(19) United States
(12) Patent Application Publication
(10) Pub. No.: US 2021/0279426 A1
(43) Pub. Date: Sep. 9, 2021

(54) LANGUAGE CUSTOMIZATION FOR MULTITENANT CLOUD-BASED SOFTWARE-AS-A-SERVICE APPLICATION

(71) Applicant: SOS SOFTWARE, INC., Yorba Linda, CA (US)

(72) Inventor: TADEUSZ PETER MATUCHNIAK, IRVINE, CA (US)

(21) Appl. No.: 17/196,483

(22) Filed: Mar. 9, 2021

Related U.S. Application Data
(60) Provisional application No. 62/987,326, filed on Mar. 9, 2020.

(51) Int. Cl. G06F 40/44; G06F 9/451; G06F 16/22; G06F 16/2455; G06F 16/23; G06F 16/248

(52) U.S. Cl. CPC G06F 40/44; G06F 9/454; G06F 16/2282; H04L 67/16; G06F 16/2379; G06F 16/248; G06F 16/2456

(57) ABSTRACT

A language customization framework leverages a cloud-based relational database structure to enable customization of language terms and prompts for multi-tenant software systems, and improves communications within such systems. The language customization framework is operable within any multi-tenancy software-as-a-service where a single instance of the software and its supporting infrastructure serves multiple customers or organizations, and to any vertical within such multi-tenant SaaS application, where language usage is unique to that vertical, unique to a particular area, or unique to a particular set of users. In the language customization framework, all files containing language content are maintained as if they are localized, fixed files, such that update of such files is dynamic and does not require a system-wide update or an update package for implementation of customizations of the language content. The selection of a specific language, and/or a specific variant of a language, is presented only as to the requesting organization user, and not to any other users in the multi-tenant software system.

### CROSS-REFERENCE TO RELATED PATENT APPLICATION(S)

This patent application claims priority to U.S. provisional application 62/987,326, filed on Mar. 9, 2020, the contents of which are incorporated in their entirety herein. In accordance with 37 C.F.R. § 1.76, a claim of priority is included in an Application Data Sheet filed concurrently herewith.

### FIELD OF THE INVENTION

The present invention relates to cloud-based software-as-a-service applications having multiple customers or organizations. Specifically, the present invention relates to systems and methods for enabling users to alter and customize language terms and prompts that are presented when accessing an account for their specific organization in such cloud-based software-as-a-service applications, and particularly where the software-as-a-service application is an organizational communications system, such that no other customer or organization shares the specific organization's customizations.

### BACKGROUND OF THE INVENTION

Organizations are continuously faced with challenges in internal communications, such as for example where a need arises to make informed decisions very quickly. In order to make such informed decisions, organizations must get feedback or input from multiple members of their organizations, many of whom are available and reachable through mobile connections on mobile devices. In addition, organizations must also communicate information to those multiple members, as well as integrate external components such as for example systems that convey alerts or commands, or devices that can assist in making those informed decisions.

In today's increasingly mobile and/or connected world, organizations are able to connect to increasingly distributed groups. However, ubiquitous mobile connectivity has not yet provided these organizations with capabilities to connect to their mobile users utilizing messaging that is quickly interpreted by users, particularly where different languages are used within an organization, or where differences in terms used exist within the same language, such confusion can be created simply by the wording used. Such confusion can result in critical errors in communications between an organization and its members, as well as between members.

Organizations are therefore faced with challenges in ensuring that communication is seamless to allow for rapid and accurate decision-making. Currently, there is no existing approach to enabling an unlimited number of language customizations within such organizational communications software, nor is there an existing approach that at the same time enables usages of variations of the same language that reflect different cultures, regions, even within a particular vertical. Neither is there an existing approach which provides for instantaneous changes in selected languages for all relevant users in all of their various interfaces that remains an entirely non-fixed file and cloud-based environment.

This occurs at least in part because of technical limitations that hamper communications among organizational personnel. The structure of existing software solutions does not lend itself to such rapid and accurate decision-making where language customization is needed within an organization.

Cloud-based software-as-a-service applications are now ubiquitous, and offer a myriad of capabilities to organizations, such as for enabling internal and external communications. Many such applications are multi-tenancy applications where a single instance of the software application and its supporting infrastructure serves multiple customers or organizations. Each organization in such a framework shares the software application, and also shares a common database environment. However, each tenant's data is isolated and remains invisible to other tenants. In typical cloud-based SaaS systems, one or more JSON files (or any text-based markup files, such as XML, CSV, etc.) are commonly provided to represent a language or languages. The number of languages supported is fixed upon installation, and the JSON files are static, in that they need to be updated by system personnel when new language terms or translations are needed. Any language translations therefore apply as a one-size-fits-all for all tenants in the multi-tenant system, and any customizations require a re-compilation of code which will be applicable for the entire population of tenants, and not for any particular tenant that requires or request such customizations. Therefore, there is simply no database mechanism in such software applications for tenant-specific language customizations, and no such mechanism for immediate applicability of such customizations without having to go through the process of a system update. Even if a database is used to store the language data, it is not customizable by the tenant for their own usage purposes.

Similarly, there is no existing approach to language customization in locally-hosted systems that are not provided as a cloud-based SaaS. As with SaaS systems, one or more JSON files represent one or more languages, and the number of languages supported is fixed upon installation. These JSON files are also static, and need to be updated by an update package when new language terms or translations are needed. The language translations apply only to the organization that installed the system locally. Immediately-applicable, tenant-specific language customizations, without having to go through the process of installation of an update package, are therefore also not possible in non-SaaS systems.

Accordingly, there is a need in the existing art for improvements at least in organizational communications systems, as well as in other operational management software systems (both SaaS and non-SaaS, that provide for support tenant-specific language customizations in SaaS systems that can be made available at the time such customizations are specified.

### SUMMARY OF THE INVENTION

The present invention is an approach for improving communications in systems such as organizational risk management systems that utilize multi-tenant software applications that are known as software-as-a-service, or SaaS. The approach is embodied in systems and methods that enable a cloud-based relational database structure to provide users with a dynamic way to customize language terms, including definitions and translations, and the linguistic prompts that users see when accessing their organization's account.

The present invention is provided within an organizational risk management system, but is also applicable to any organizational software application. In addition, the present invention may be applied in real-time for any vertical within an organizational software application, such as a localized presentation where language usage is unique to that vertical and/or unique to a particular geographical region. The present invention allows for users to implement a selected language variation throughout an entire vertical just for that particular customer, while still remaining entirely within a cloud-based, non-fixed file environment.

The approach of the present invention is operable within broader organizational software systems as noted above. In one aspect thereof, the present invention is operable within a structured messaging system that provides a private, secure, and auditable means of coordination between an organization system and individual, or groups, of its mobile users. The present invention is also operable within a system that acts a duty of care service for organizations or for risk management companies that provides integrated, pre- and post-loss risk management for mitigating physical and operational risks as well as liability losses. Such a service, which may be referred to herein as “InSite” herein, provides risk assessment and mitigation that combines, in one embodiment thereof, the Internet of Things (IoT) with an Internet of Persons™ (IoP) to deliver a risk management service for organizations in a private, secure, and auditable means of coordination between an organization and its stakeholders.

Within such broader systems, the software-based approach of the present invention provides a dynamic means for a customer to alter the language terms and prompts that are displayed to them when they access their organization's account. Such capability is provided in an unlimited number of languages, including variations on the same language that reflect different cultures or regions. The organizational user has complete control over these customizations within a management or administrative portal, and any selected changes occur almost instantaneously for all users of the broader system, within the context of their organization through various user interfaces, such as dedicated mobile apps, admin screens, reports, etc. With the approach of the present invention, each organization has its own unique language views that are not visible to any other organization, and yet all of these variations may reside within a single hosted system that provides multitenant access.

Accordingly, it is one objective of the present invention to provide multitenant language customization for users with an organizational software system. It is another objective of the present invention to provide an unlimited number of baseline language translations within a framework for such multitenant language customization. It is a further objective of the present invention to provide an unlimited number of baseline variations on any given language within such a framework. It is still a further objective of the present invention to enable an unlimited number of organizations with their own custom variations on those baseline variations, within such a framework.

It is yet another objective of the present invention to provide a framework for multitenant language customization that includes relational database-driven storage of all language data, so as to be highly flexible and with limitless variations, as well as enabling customization that is specific to verticals within an organization. It is another objective of the present invention to enable dynamic update and retrieval of data by any customer, with no static limitations on language data, within such a framework, without having to wait for either an update by system personnel, or installation of an update package. It is still another objective of the present invention to enable a real-time display of customized changes in user interfaces, where changes are reflected immediately, within such a framework, and it is still a further objective of the present invention to enable storage of multiple organizations' language customizations within a single cloud or hosted system (e.g. SaaS), within such a framework. Further, it is an objective of the present invention to provide for multitenant language customization in which there is no overlap in language terms between organizations' customizations, and no ability for users to see other organizations' customizations.

Other objectives, embodiments, features, and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a systemic diagram illustrating elements of a language customization framework according to the present invention;

FIG. 2 is an entity relationship diagram for the language customization framework according to one aspect of the present invention;

FIG. 3 is a chart of table definitions for relational database tables for the language customization framework according to one aspect of the present invention;

FIG. 4 is a flowchart of steps in a process of performing the language customization framework according to one embodiment of the present invention; and

FIG. 5 is an exemplary screenshot of a management portal the language customization framework, showing implementations of user language preferences; and

FIG. 6 is an exemplary screenshot of a management portal the language customization framework, showing further implementations of user language preferences for a different tenant than that shown in FIG. 5.

### DETAILED DESCRIPTION OF THE EMBODIMENT(S) OF THE INVENTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

The approach of the present invention is a language customization framework 100 for improving communications in systems, such as for example organizational risk management systems, that utilize multi-tenant software applications 104 that are known as software-as-a-service, or SaaS. The language customization framework 100 is performed in one or more systems and methods that leverage a cloud-based relational database structure 146 to enable customization of language definitions, terms, translations 116, and prompts 177 for entry and selection of language preferences, for any multi-tenancy organizational software system. The present invention is provided, one exemplary embodiment, within an organizational risk management system, but is also applicable to any organizational software application, and to any vertical within an organizational software application, where language usage is unique to that vertical, unique to a particular area, or unique to a particular set of users.

The language customization framework 100 of the present invention is operable as noted above within a broader organizational software architecture, such as a messaging and risk management system, for example one in which customers utilize the broader system on a software-as-a-subscription or platform-as-a-service basis. Regardless of how customers purchase or otherwise engage to access such as a system, the language customization framework 100 presents a combination of language customization features which together enable users to view content according to their own language preferences, whether it be a variant on a particular language, a language specific to a particular region, or language customary for a particular vertical.

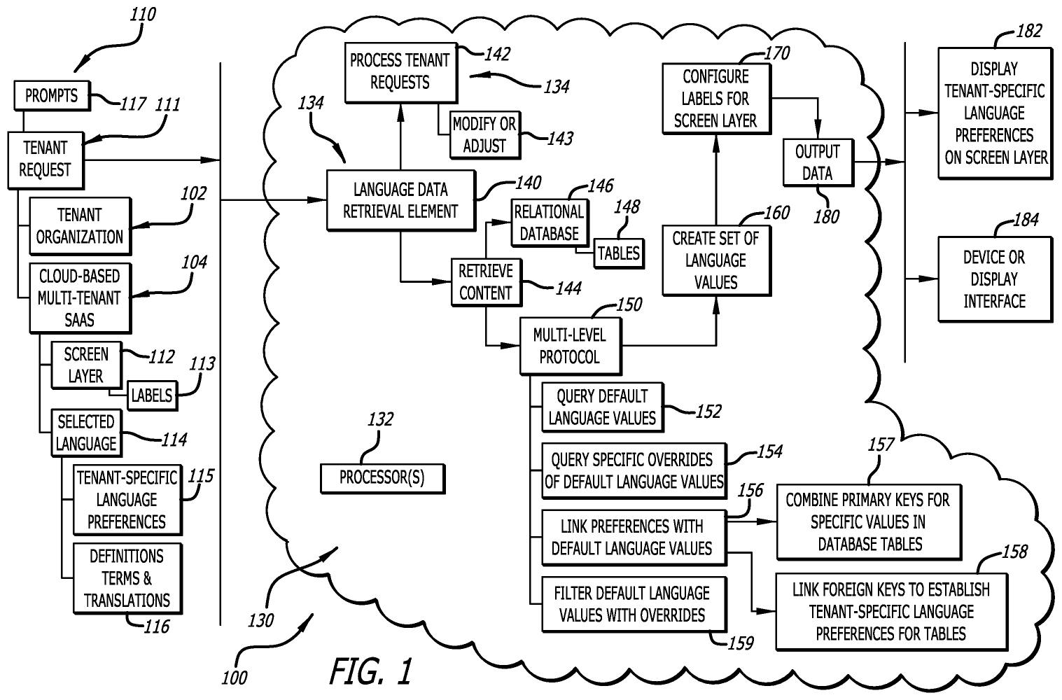

FIG. 1 shows a systemic diagram of a language customization framework 100 for enabling organization users or tenants 102, to customize and view tenant-specific language preferences 115 for a selected language 114, within a multi-tenant, cloud-based, software-as-a-service (SaaS) application 104. Such a language customization framework 100 is configured to enable a dynamic presentation of the tenant-specific language preferences 115 for different fields or labels 113 presented by the SaaS on one or more screen layers 112, which may be viewed by the tenant 102 on any device or display interface on which the multi-tenant, cloud-based SaaS 104 may be configured.

In the language customization framework 100, input data 110 at least in the form of tenant requests 111 made using the device or display interface 184 on which the multi-tenant, cloud-based SaaS 104 may be configured, are received and processed to retrieve language content for a selected language 114 for representation and display 182 thereof on a display interface 184. The language customization framework 100 is performed as noted above within one or more systems and/or methods that include several components, each of which define distinct activities and functions for processing tenant requests 111 to effect a presentation and display of the tenant-specific language preferences 115, and to enable dynamic indication of such preferences 115 as modifications or adjustments 143 generated by tenants 102, for example via one or more prompts 117 to enter preferences 115.

The language customization framework 100 ingests, receives, requests, or otherwise obtains input data 110 in the form of tenant requests 111 that represent either indications to view previously-identified tenant-specific language preferences 115 that include customized language content comprising definitions, terms, or translations 116 of a selected language 114, or to accept dynamic requests to modify or adjust 143 the definitions, terms, or translations 116 of a selected language 114 that become tenant-specific language preferences 115. In either case, the language customization framework 100 presents the tenant-specific language preferences 115 to the specific requesting tenant 102 instantaneously or near-instantaneously, so that each tenant 102 within the multi-tenant cloud-based SaaS 104 has its own unique language views that are not visible to any other tenant 102, and yet which reside within a single hosted system that provides multitenant access, without requiring either a system-wide update or an update package for implementation of the customizations presented in the modifications or adjustments of the language content.

Tenant requests 111 are processed within a plurality of data processing elements 134 in the language customization framework 100 that are components within a computing environment 130 that may also include one or more processors 132 and a plurality of software and hardware components. The one or more processors 132 and plurality of software and hardware components are configured to execute program instructions or routines stored within at least one computer-readable non-transitory storage medium to perform the functions described herein, and embodied within the plurality of data processing elements 134. The computing environment 130 may comprise, at least in part, a cloud-based relational database structure 146, within which a multi-level protocol 150 is executed to perform the features of the language customization framework 100 described herein.

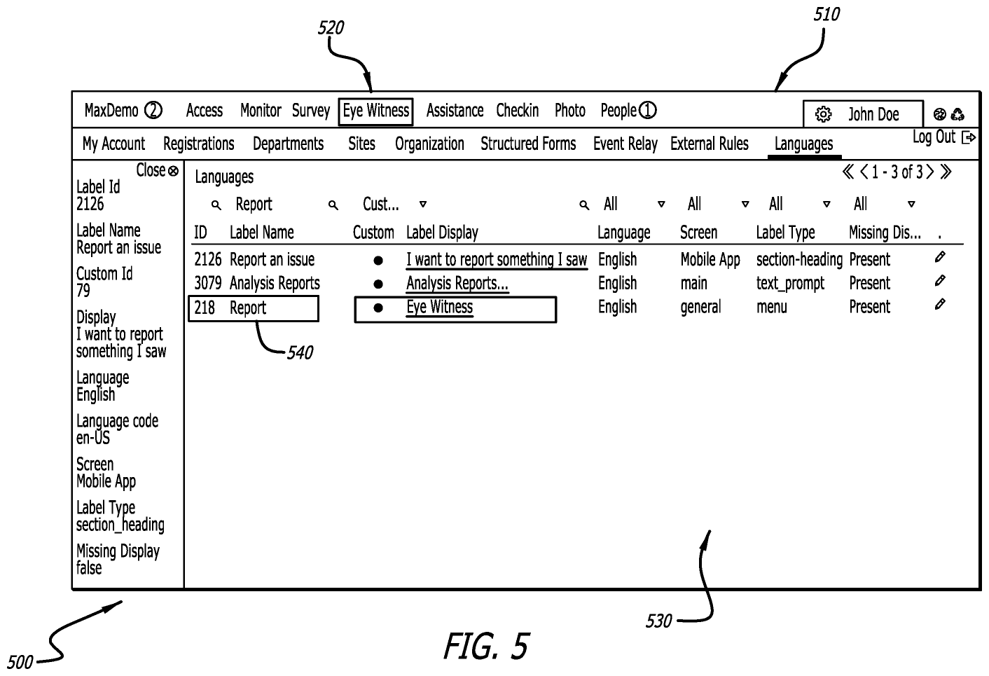

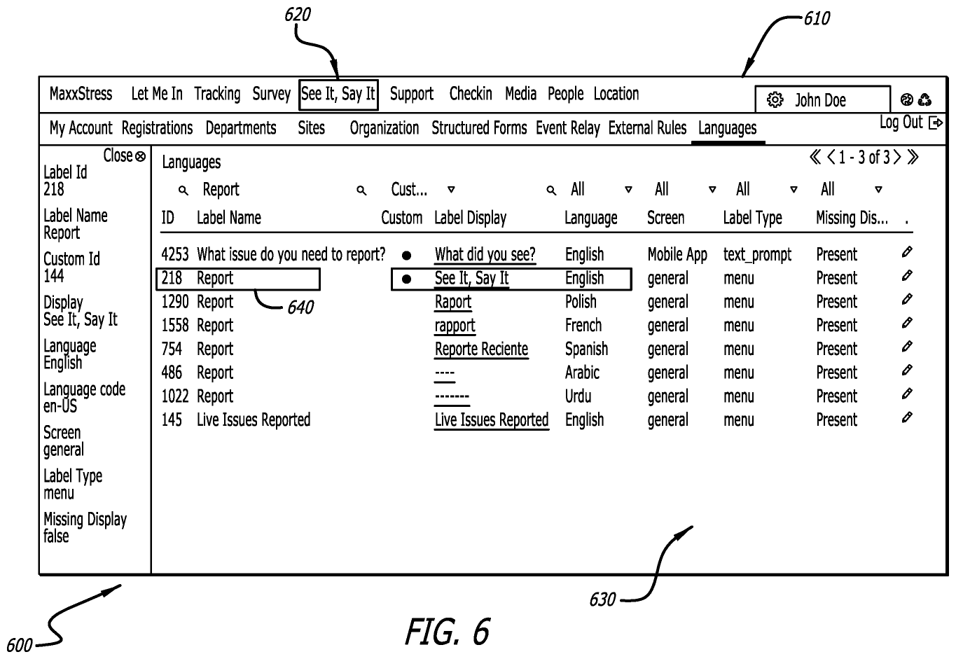

The plurality of data processing elements 134 includes a language data retrieval element 140, which is configured to process 142 tenant requests 111, and to retrieve and store language content 144 from one or more relational database structures 146. The processing 142 of tenant requests 111 includes, as noted above, both requests to view previously-identified tenant-specific language preferences 115, as well as prompts 117, such as for example menu dropdowns or other ways to select or input text, to modify or adjust 143 the definitions, terms, or translations 116 of a selected language 114 that represent selected tenant-specific language preferences 115. These may be provided by each tenant 102 via the one or more screen layers 112, and labels or fields 113 within each screen layer 112, as shown further in FIG. 5 and FIG. 6, on a device or display interface 174.

Content retrieval 144 occurs in response to a tenant request 111 to access or view labels 113 with selected tenant-specific language preferences 115. The language customization framework 100 executes the multi-level protocol 150 to configure the labels 113 with the selected tenant-specific language preferences 115.

The multi-level protocol 150 includes querying one or more database tables 148 in the relational database 146 for default language values 152 to retrieve the default definitions, terms and translations 116 for the selected language 114 in response to a tenant request 111. The multi-level protocol 150 includes querying one or more database tables 148 in the relational database 146 for specific overrides 154 of the default language values that represent the selected tenant-specific language preferences 115.

The multi-level protocol 150 then performs a Cartesian product joinder to link data values 156 comprising the selected tenant-specific language preferences 115 for the selected language 114 in the queried specific overrides 154 with the queried default language values 152 in the one or more database tables 148. This is accomplished by combining one or more primary keys 157 that identify at least one specific term, a specific tenant, and a specific language in the one or more database tables 148 to characterize foreign keys representing at least one of a label identifier, an organization identifier, and a language identifier that represent the selected tenant-specific language preferences 115 for each of the one or more labels 113 in the one or more database tables 148, and then by linking the foreign keys 158 to establish the selected tenant-specific language preferences 115 for the one or more labels 113. Therefore, the multi-level protocol 150 effectively identifies primary keys in each database table 148 representing the label, the tenant, and the language that point to tenant-specific preferences 115, and then links foreign keys representing the actual preferences which, when combined, represent the selected tenant-specific language preferences 115.

The multi-level protocol 150 then filters 159 out the default language values where there are specific overrides in the one or more database tables 148 representing selected tenant-specific language preferences 115, to create a set of language values 160 for the specific tenant 102. The language customization framework 100 then configures labels 113 with the selected tenant-specific language preferences 115, and presents the selected tenant-specific language preferences 115 for the one or more labels 113 on the at least one screen layer 112 for the specific tenant 102. The selection of tenant-specific language preferences 115 is therefore accomplished entirely within the cloud-based relational database structure 146, such that there are no local, fixed files, and without the need for either a system-wide update or an update package for implementation of the customizations selected by the specific tenant 102.

A similar approach applies where a particular tenant 102 wishes to update the definitions, terms, or translations 116 comprising the language content of the selected language 114. Using prompts 117 provided, for example, via pulldown menus for labels 113 accessed on a screen layer 112, a user-tenant 102 need only to select a language preference 115 for the relational database 146 to be updated (either to change a particular term, or to add an entirely new set of language content). In both aspects of the present invention, where the user-tenant 102 either selects pre-provided customized language content, or updates the relational database 146 with language preferences 115, the language customization framework 100 dynamically stores all language definitions, terms and translations 116 in the cloud-based relational database 146, so that any updates are simply applied to the database 146 and are effective immediately with no system updates, only for the tenant 102 who specifies the customizations.

A tenant request 111 for tenant-specific language preferences 115 may therefore occur in a number of ways within the language customization framework 100. Tenants 102 may initiate views of their tenant specific language preferences 115 via prompts 117 as discussed above. Alternatively, stored preferences 115 may be automatically viewed for labels 113 on the screen layers 112 from user login credentials. Prompts 117 may also be utilized to select or specify definitions, terms, and translations 116, and entirely different languages or variant thereof, as well as to enter in new language values as the tenant's own definitions, terms, and translations 116.

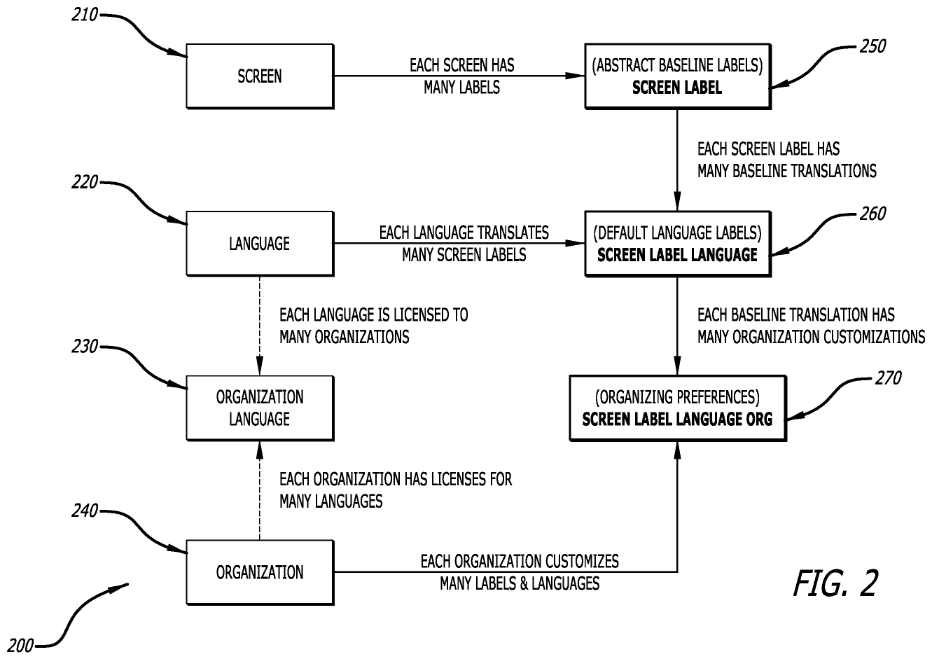

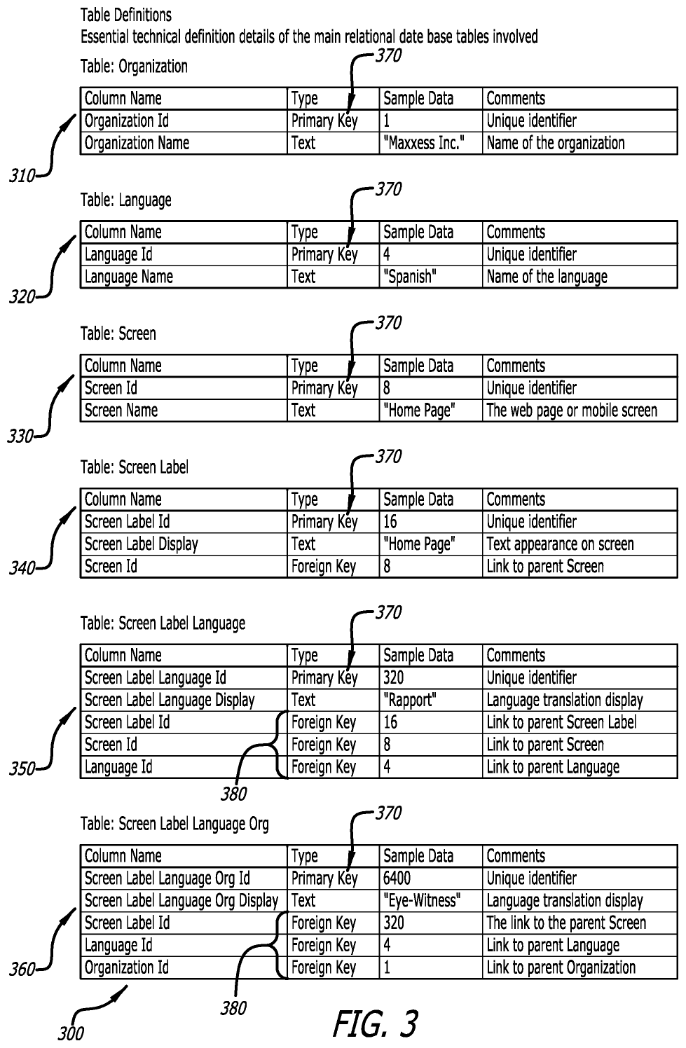

FIG. 2 and FIG. 3 are technical illustrations of how the language customization framework 100 operates to permit selected tenant-specific language preferences 115 to be enabled for a selected language 114 for each tenant 102, without the need for updated JSON files to present or change tenant-specific language settings. FIG. 2 is a logical database design diagram that directly represents the underlying physical database structure 200 for application of the multi-level protocol 150 within the language customization framework 100, according to one aspect of the present invention. In FIG. 2, each level 210, 220, 230 and 240 is shown relative to a correspondence label, or topic, 250, 260 and 270, each of which represent a different level of depth within the structure of the relational database 146. FIG. 2 illustrates the relationship between each level and corresponding topic of content stored in a relational database for each tenant. FIG. 3 is an illustration of technical definition details of relational database tables 300 in the language customization framework 100. Each specific table 310-360 contains content for a selected language, and identifies primary keys 370 that represent specific content, and foreign keys 380 representing links to content in other tables that identify tenant-specific language preferences 115 for each tenant 102.

Together, FIG. 2 and FIG. 3 indicate that a relational database 146 structure for the language customization framework 100 enables a multi-level protocol 150 that enables tenant specifications and customizations for language variations, without the need for updated JSON files to change tenant settings. The structure of a relational database 146 in the present invention may include a baseline language table, which is common to all users, as well as a language variation table that includes all possible variations of languages, and a language variable table that includes all customer specifications. This enables a number of functions within the multi-level protocol 150 that provide a high degree of flexibility for each organizational user to create language views that are suitable for a specific location, vertical, or user base. These functions include an unlimited number of baseline language translations, so that any language may be represented in the present invention. Additionally, functions include an unlimited number of baseline variations on any given language, such as for example variations within the English language representing United States English, British English, Canadian English, Australian English, etc. Furthermore, any tenant 102 can provide their own customizations per each variation for exclusive use within their own organization.

The multi-level protocol 150 of the language customization framework 100 also enables an unlimited number of tenant organizations, each having with their own custom variations on those baseline variations. FIG. 2 and FIG. 3 demonstrate that relational database-driven storage of all language data is highly flexible, and has limitless variations within the language customization framework 100, as well as the dynamic update and retrieval of language content by any customer with no static data limitations. The language customization framework 100 also enables a real-time display of customized changes in all user interfaces, with changes reflected immediately following selection by a user tenant. Still further, the language customization framework 100 includes storage of multiple organizations' language customizations within one single cloud-based or hosted system, without overlap in language terms between organizations' customizations, and providing that no organization has the ability to see any other organizations' language customizations.

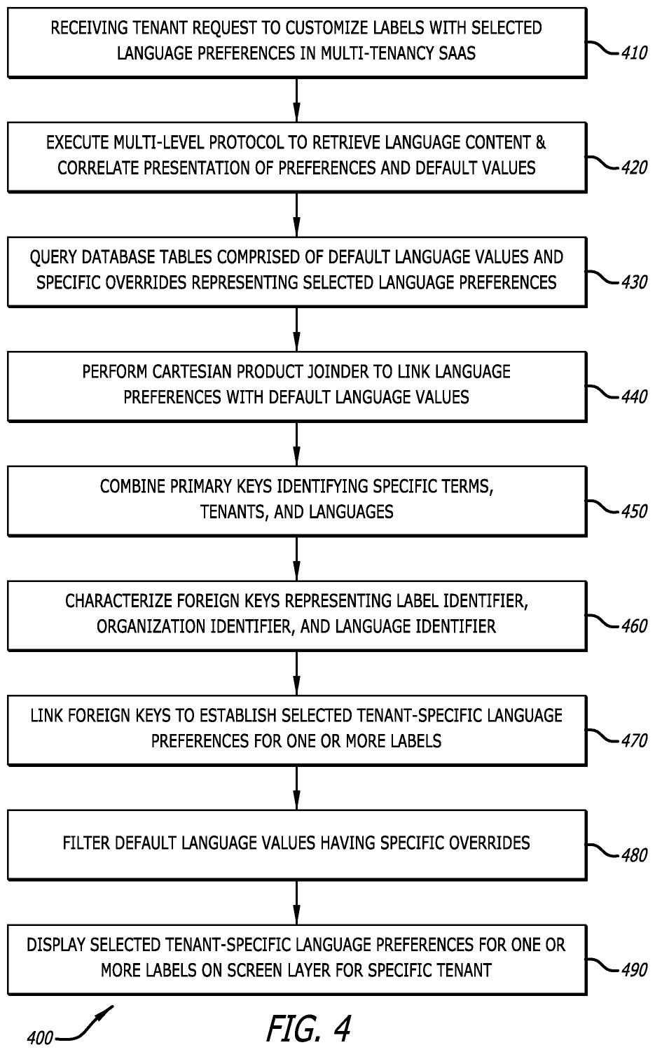

FIG. 4 is a flowchart illustrating steps in a process 400 for performing the language customization framework 100, according to one or more embodiments of the present invention. Such a process 400 may include one or more functions, mathematical models, algorithms, machine learning processes, and data processing techniques for the data processing elements 134 within such a framework 100, and for the various functions of each element 134, for dynamically enabling customization, selection, and visualization of tenant-specific language preferences 115 without the need for updated JSON files to change tenant language settings in either a system-wide update or an update package.

The process 400 is initialized at step 410 by receiving and processing input data 110 in the form of tenant requests 111 for the customization, selection, or visualization of labels 113 with tenant-specific language preferences 115 in a multi-tenant, cloud-based SaaS 104. At step 420, the process 400 then executes the multi-level protocol 150 to retrieve language content and correlate the presentation of tenant-specific language preferences 115 and default language values in response to a tenant request 111.

At step 430, the multi-level protocol 150 initiates database queries of the relevant relational database(s) 146. These queries include a query 152 of database tables 148 comprised of default language values, as well as a query 154 of database tables 148 that are comprised of specific overrides to the default language values, representing selected, tenant-specific language preferences. At step 440, the multi-level protocol 150 links the two datasets comprising the selected tenant-specific language preferences 115 with the default language values, for example by performing a Cartesian product joinder on the datasets.

More specifically, this is accomplished, as indicated in step 450, by combining primary keys that identify specific terms, tenants, and languages relative to the specific tenant 102 and the selected language 114 in the datasets retrieved from the relational database 146 collections, and at step 460, by characterizing foreign keys as representing one or more of a label identifier, an organization or tenant identifier, or a language identifier that point to the primary keys for the desired information to be presented to a specific tenant 102. At step 470, the process 400 then links the foreign keys to establish selected tenant-specific language preferences 115 for one or more labels for the specific, requesting tenant, and at step 480, filters 159 out default language values having specific overrides for the selected tenant-specific language preferences 115, to create a set of language values 160 for the specific tenant 102. At step 490, the process 400 then presents the selected tenant-specific language preferences 115 for the specific tenant 102, by displaying the curated set of language values for one or more labels 113 on the screen layer or layers 112, via a device or a display interface configured with a device.

Several examples of language customization may be instructive as to the nature and scope of the present invention, as follows.

Within the broader organizational messaging and risk management software architecture in which the language customization framework 100 is operable according to one embodiment of the present invention, consider that the baseline term for reporting an issue is “Report.” A particular organization may prefer the term “See Something, Say Something” for their United States offices, but have a variation for their United Kingdom offices such as “See it, Say it, Sorted.” With the present invention, users within that organization would see the appropriate prompt or label based on their user account profile, which can be changed dynamically to reflect their preference. Alternatively, users may see the appropriate prompt or label based on an automatically-identified location for users identified as being within a particular segment of the organization.

Another unrelated organization, for example a school, may prefer to override “Report” with “Eye Witness,” and use that universally for all their English-speaking users. This school's users would only see “Eye Witness” on interfaces on their displays or screens or in their reports, and not the customizations used by first organization above.

In both of these examples, the organizations could apply the same customizations to an unlimited number of languages supported by the organizational software system (such as, as noted throughout, an organizational messaging and risk management software architecture), in the same manner as described above for any given language.

User language preferences 115 may be determined or inferred in the language customize framework 100 by a user tenant either directly via a management portal as shown in FIG. 5 and FIG. 6, or from a mobile application configured on a mobile device such as a tablet, “smart” telephone, “smart” watch, or any other mobile device. Regardless of the tenant's device or interface, the languages presented for selection would be those available or licensed to that organization, and may be quite different to the list presented to another organization.

FIG. 5 is an exemplary screenshot 500 of a management portal for sample tenant called “MaxxDemo”, where a display or interface 510 presents a screen layer 530 on which a menu bar of available labels 530 are available for selection by a user tenant. In FIG. 5, a standard or baseline label 540 for “Report” is replaced by a tenant-specific preference for “Eye Witness” and this label 540 is displayed both on the menu bar and on the “Label Display” list for the label “Report” when selected. This represents selected language content as override for the particular label “Report,” with the override or selected tenant-specific preference 115 for “Eye Witness”. Only the MaxxDemo tenant 102 will see this preference; for all other user tenants in the multi-tenant cloud-based SaaS 104, either the baseline term will be displayed, or their own, selected, tenant-specific language preference 115 for this particular label 530.

This is shown in FIG. 6, which is an exemplary screenshot 600 of a management portal for different tenant 102 called “MaxxStress.” In FIG. 6, a display or interface 610 presents a screen layer 630 on which a menu bar of available labels 620 are available for selection by the user-tenant 102. In FIG. 6, the screen layer 630 displays selected preferences for MaxxStress in some different labels 620 across the menu bar of labels 620 than that of MaxxDemo. The standard or baseline label 640 for “Report” is replaced by a tenant-specific preference 115 for “See It, Say It” and this label 640 is displayed both on the menu bar and on the “Label Display” list for the label “Report” when selected. In addition, menu bar labels 620 for MaxxStress include “Let Me In” instead of “Access”, and “Tracking” instead of “Monitor”—representing selections of other variations for the terms available for each of those menu bar labels 620.

The systems and methods of the present invention may be implemented in computing environments 130 having many different variations, and in many different types of software systems. For example, the various algorithms embodied in the data processing elements 134 may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, GPU and any comparable means. Still further, the present invention may be implemented in cloud-based data processing environments, and where one or more types of servers are used to process large amounts of data, and using processing components such as CPUs, GPUs, TPUs, and other similar hardware. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors or general processing units), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be wholly or partially implemented in software that can be stored on a non-transitory computer-readable storage medium, executed on programmed general-purpose computer with the cooperation of a controller and memory, a special purpose computer, a microprocessor, or the like. In these instances, the systems and methods of this invention can be implemented as a program embedded on a mobile device or personal computer through such mediums as an applet, JAVA® or CGI script, as a resource residing on one or more servers or computer workstations, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, machine learning, artificial intelligence, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method of tenant-specific language customization for cloud-based multi-tenant software-as-a-service applications, comprising:
querying, in response to a tenant request to customize one or more labels with selected tenant-specific language preferences on at least one screen layer within a multi-tenant software-as-a-service application, one or more database tables comprising default language values for a selected language, and querying the one or more database tables for specific overrides for the default language values, the specific overrides representing the selected tenant-specific language preferences for the selected language;
performing a Cartesian product joinder to link data values comprising the tenant-specific language preferences for the selected language in the specific overrides with the default language values in the one or more database tables, by:
combining one or more primary keys that identify at least one specific term, a specific tenant, and a specific language in the one or more database tables to characterize foreign keys representing at least one of a label identifier, an organization identifier, and a language identifier that represent the selected tenant-specific language preferences for each of the one or more labels in the one or more database tables, and
linking the foreign keys to establish the selected tenant-specific language preferences for the one or more labels;
omitting the default language values having the specific overrides, to present the selected tenant-specific language preferences for the one or more labels on the at least one screen layer for a specific tenant in the multi-tenant software-as-a-service application.

2. The method of claim 1, wherein the multi-tenant software-as-a-service application provides a risk management software architecture.

3. The method of claim 2, wherein the selected tenant-specific language preferences are displayed to the specific tenant on one or more graphical user interfaces configured to display the at least one screen layer.

4. The method of claim 1, wherein at least the default language values for the selected language includes language data that includes language definitions, language terms, and language translations.

5. The method of claim 4, wherein the omitting the default language values having the specific overrides further comprises filtering language data returned for each tenant by the language identifier.

6. The method of claim 1, wherein the default language values, the specific overrides, and the selected tenant-specific language preferences are stored in the one or more database tables in a relational database.

7. The method of claim 1, wherein tenant modifications comprising the specific overrides dynamically update the one or more database tables as the tenant modifications are added as inputs into the multi-tenant software-as-a-service application.

8. The method of claim 1, wherein the querying one or more database tables comprising default language term values further comprises determining a default tenant and a default tenant language from credentials of the specific tenant.

9. The method of claim 1, wherein the multi-tenant software-as-a-service application accepts tenant requests to select and customize the default language values for the selected language, without having to update JavaScript Object Notation (JSON) language files in either a system update or an update package for the one or more database tables.

10. The method of claim 1, wherein where the tenant request does not indicate a preference for a specific label, the default language values are presented for the selected language for the specific label, and the primary key is comprised of only the label identifier and the language identifier.

11. The method of claim 1, wherein the tenant request to customize one or more labels with selected tenant-specific language preferences represents a selection of either or both of a specific language or a language variant within the selected language.

12. A method of customizing language values within a cloud-based multi-tenant software-as-a-service application, comprising:
receiving, within at least one screen layer provided in a multi-tenancy software-as-a-service application, a request from a specific tenant to customize one or more labels with selected tenant-specific language preferences;
retrieving content for a selected language in response to the request from the specific tenant, and correlating a presentation of the selected tenant-specific language preferences and default language values for the selected language, by executing a multi-level protocol within a cloud-based relational database structure to associate the at least one screen layer with the selected tenant-specific language preferences, the multi-level protocol comprising:
querying one or more database tables comprising the default language values for the selected language,
querying the one or more database tables for specific overrides for the default language values, the specific overrides representing the selected tenant-specific language preferences for the selected language,
linking data values comprising the tenant-specific language preferences for the selected language in the specific overrides with the default language values in the one or more database tables, by performing a Cartesian product joinder to combine one or more primary keys that identify at least one specific term, a specific tenant, and a specific language in the one or more database tables to characterize foreign keys representing at least one of a label identifier, an organization identifier, and a language identifier that represent the selected tenant-specific language preferences for each of the one or more labels in the one or more database tables, and link the foreign keys to establish the selected tenant-specific language preferences for the one or more labels, and
filtering out the default language values having the specific overrides; and
displaying the selected tenant-specific language preferences for the one or more labels on the at least one screen layer for a specific tenant.

13. The method of claim 12, wherein the multi-tenant software-as-a-service application provides the multi-level protocol within a risk management software architecture.

14. The method of claim 13, wherein the selected tenant-specific language preferences are displayed to the specific tenant on one or more graphical user interfaces configured to display the at least one screen layer.

15. The method of claim 12, wherein at least the default language values for the selected language includes language data that includes language definitions, language terms, and language translations.

16. The method of claim 15, wherein the multi-level protocol further comprises filtering language data returned for each tenant by the language identifier.

17. The method of claim 12, wherein the default language values, the specific overrides, and the selected tenant-specific language preferences are stored in the one or more database tables in the cloud-based relational database structure.

18. The method of claim 12, wherein tenant modifications comprising the specific overrides dynamically update the one or more database tables as the tenant modifications are added as inputs into the multi-tenant software-as-a-service application.

19. The method of claim 12, wherein the multi-level protocol further comprises determining a default tenant and a default tenant language from credentials of the specific tenant.

20. The method of claim 12, wherein the multi-tenant software-as-a-service application accepts tenant requests to select and customize the default language values for the selected language, without having to update JavaScript Object Notation (JSON) language files in either a system update or an update package for the one or more database tables.

21. The method of claim 12, wherein where the tenant request does not indicate a preference for a specific label, the default language values are presented for the selected language for the specific label, and the primary key is comprised of only the label identifier and the language identifier.

22. The method of claim 12, wherein the tenant request to customize one or more labels with selected tenant-specific language preferences represents a selection of either or both of a specific language or a language variant within the selected language.

23. A language customization system for cloud-based multi-tenant software-as-a-service applications, comprising:
a data retrieval element configured to receive, within at least one screen layer provided in a multi-tenancy software-as-a-service application, a request from a specific tenant to customize one or more labels with selected tenant-specific language preferences, retrieve content for a selected language in response to the request from the specific tenant, and correlate a presentation of the selected tenant-specific language preferences and default language values for the selected language, by executing a multi-level protocol within a cloud-based relational database structure to associate the at least one screen layer with the selected tenant-specific language preferences, the multi-level protocol configured to:
query one or more database tables comprising the default language values for the selected language,
query the one or more database tables for specific overrides for the default language values, the specific overrides representing the selected tenant-specific language preferences for the selected language,
link data values comprising the tenant-specific language preferences for the selected language in the specific overrides with the default language values in the one or more database tables, by performing a Cartesian product joinder to combine one or more primary keys that identify at least one specific term, a specific tenant, and a specific language in the one or more database tables to characterize foreign keys representing at least one of a label identifier, an organization identifier, and a language identifier that represent the selected tenant-specific language preferences for each of the one or more labels in the one or more database tables, and link the foreign keys to establish the selected tenant-specific language preferences for the one or more labels, and
filter out the default language values having the specific overrides; and
a display element configured to display the selected tenant-specific language preferences for the one or more labels on the at least one screen layer for a specific tenant.

24. The system of claim 23, wherein the multi-tenant software-as-a-service application provides the multi-level protocol within a risk management software architecture.

25. The system of claim 24, wherein the selected tenant-specific language preferences are displayed to the specific tenant on one or more graphical user interfaces configured to display the at least one screen layer.

26. The system of claim 23, wherein at least the default language values for the selected language includes language data that includes language definitions, language terms, and language translations.

27. The system of claim 26, wherein the multi-level protocol is further configured to filtering language data returned for each tenant by the language identifier.

28. The system of claim 23, wherein the default language values, the specific overrides, and the selected tenant-specific language preferences are stored in the one or more database tables in the cloud-based relational database structure.

29. The system of claim 23, wherein tenant modifications comprising the specific overrides dynamically update the one or more database tables as the tenant modifications are added as inputs into the multi-tenant software-as-a-service application.

30. The system of claim 23, wherein the multi-level protocol is further configured to determine a default tenant and a default tenant language from credentials of the specific tenant.

31. The system of claim 23, wherein the multi-tenant software-as-a-service application accepts tenant requests to select and customize the default language values for the selected language, without having to update JavaScript Object Notation (JSON) language files in either a system update or an update package for the one or more database tables.

32. The system of claim 23, wherein where the tenant request does not indicate a preference for a specific label, the default language values are presented for the selected language for the specific label, and the primary key is comprised of only the label identifier and the language identifier.

33. The system of claim 23, wherein the tenant request to customize one or more labels with selected tenant-specific language preferences represents a selection of either or both of a specific language or a language variant within the selected language.
